(19) United States
(12) Patent Application Publication
(10) Pub. No.: US 2025/0377030 A1
(43) Pub. Date: Dec. 11, 2025

(54) TAPERED SPRING WITH CHANGEABLE TOP SIZE, SPRING MODULE, AND ELASTIC CUSHION

(71) Applicant: Luhao LENG, Xiamen (CN)

(72) Inventor: Luhao LENG, Xiamen (CN)

(21) Appl. No.: 19/230,199

(22) Filed: Jun. 6, 2025

(30) Foreign Application Priority Data
Jun. 7, 2024 (CN) 202410740805.3

(51) Int. Cl. F16F 1/04; A47C 27/06

(52) U.S. Cl. CPC F16F 1/041; A47C 27/061; F16F 2230/0052

(57) ABSTRACT

A tapered spring with a changeable top size includes a spring, a tapered fixed sleeve, and an adjustment member. The adjustment member is disposed at a top of the tapered fixed sleeve, and the top of the tapered fixed sleeve is a small end of the tapered fixed sleeve. The adjustment member includes an expandable portion configured to be expanded and contracted along a horizontal direction on a top end surface of the adjustment member, and the expandable portion is configured to be expanded outward to form an outward expansion surface on the top end surface of the adjustment member. When the expandable portion is expanded, a projection of the expandable portion in a vertical direction is less than or equal to a projection of a bottom of the tapered fixed sleeve, and the bottom of the tapered fixed sleeve is the large end of the tapered fixed sleeve.

### RELATED APPLICATIONS

This application claims priority to Chinese patent application number 202410740805.3, filed on Jun. 7, 2024. Chinese patent application number 202410740805.3 is incorporated herein by reference.

### FIELD OF THE DISCLOSURE

The present disclosure relates to the technical field of household springs, and particularly to a tapered spring with a changeable top size, a spring module, and an elastic cushion.

### BACKGROUND OF THE DISCLOSURE

Household springs are commonly used in furniture, mattresses, chairs, seats, sofas, and other equipment to provide elastic support and shock absorption, enhancing comfort and durability. Different household devices require varying types and shapes of springs.

Household springs possess high elasticity, enabling them to support various household devices while offering excellent cushioning and elastic support. Through elastic deformation and rebound, household springs provide support, which is one of their key functions.

As a support, the top of a spring must have sufficient load-bearing capacity and strength to withstand the required pressure and load. The top size of known spring modules is typically determined based on practical application needs and the specific structure of the spring module. During manufacturing, the dimensions of the spring are usually defined according to usage requirements and design specifications. The top size of the spring must correspond to other dimensional parameters, such as the diameter and length, to ensure the structural rationality and stability of the entire spring module.

Currently, the top size of a spring is generally fixed during design and manufacturing and cannot be arbitrarily altered, as parameters like spring dimensions, wire diameter, and material are determined based on design and application requirements. Consequently, the top size of the spring is also fixed. Attempting to change the top size during use may disrupt performance and structural balance of the spring, thereby affecting the stability and service life of the spring module.

Therefore, the technical problem to be solved by the present disclosure is how to enable the top size of the spring to be adjusted freely without compromising the stability of the spring module or causing imbalances in the performance and structural balance of the spring.

### BRIEF SUMMARY OF THE DISCLOSURE

The technical problem to be solved by the present disclosure is to provide a tapered spring with a changeable top size, a spring module, and an elastic cushion.

In order to solve the above technical problems, the present disclosure provides a tapered spring with a changeable top size, and the tapered spring comprises a spring, a tapered fixed sleeve, and an adjustment member. The spring is configured as a tapered structure, and the spring is mounted in the tapered fixed sleeve.

The adjustment member is disposed at a top of the tapered fixed sleeve, and the tapered fixed sleeve comprises a small end and a large end larger than the small end. The top of the tapered fixed sleeve is the small end of the tapered fixed sleeve.

The adjustment member comprises an expandable portion, and the expandable portion is configured to be expanded and contracted along a horizontal direction on a top end surface of the adjustment member. The expandable portion is configured to be expanded outward to form an outward expansion surface on the top end surface of the adjustment member.

When the expandable portion is expanded, a projection of the expandable portion in a vertical direction is less than or equal to a projection of a bottom of the tapered fixed sleeve, and the bottom of the tapered fixed sleeve is the large end of the tapered fixed sleeve.

In a preferred embodiment, the adjustment member comprises a rotating portion, and the rotating portion is rotatably connected to the top of the tapered fixed sleeve.

The rotating portion is configured to be rotated to drive the expandable portion to be expanded outward or contracted inward along the horizontal direction.

In a preferred embodiment, the expandable portion comprises a plurality of blades, and the plurality of blades are configured to be spliced in a shape of a circle. The plurality of blades are petal-shaped movable sheets.

In a preferred embodiment, the rotating portion comprises a base disc and a rotating disc, and the base disc is a fixed disc fixedly connected to the top of the tapered fixed sleeve.

The rotating disc is rotatably mounted on the base disc, and the plurality of blades are movably mounted on the rotating disc.

In a preferred embodiment, the base disc comprises a plurality of sliding rails, and the rotating disc comprises a plurality of guiding rails. A bottom of each of the plurality of blades comprises a first sliding block and a second sliding block.

The first sliding block is slidably connected in a corresponding one of the plurality of guiding rails, and the second sliding block is slidably connected in a corresponding one of the plurality of sliding rails. Each of the plurality of blades is configured to be expanded and contracted horizontally due to cooperation between the first sliding block and the corresponding one of the plurality of guiding rails and cooperation between the second sliding block and the corresponding one of the plurality of sliding rails.

In a preferred embodiment, each of the plurality of blades corresponds to a single one of the plurality of sliding rails on the base disc and a single one of the plurality of guiding rails on the rotating disc.

In a preferred embodiment, the plurality of sliding rails are arc-shaped rails, and the plurality of guiding rails are linear guiding rails.

A bottom of each of the plurality of guiding rails comprises a channel, and the second sliding block passes through the channel and slides in the corresponding one of the plurality of sliding rails.

In a preferred embodiment, the tapered spring is hollow, and the tapered spring is configured to be stacked with other tapered springs.

When the expandable portion is contracted, the projection of the expandable portion in the vertical direction is less than or equal to a projection of the top of the tapered fixed sleeve.

The present disclosure provides a spring module, and the spring module comprises a plurality of tapered springs and a plurality of bases. The plurality of tapered springs and the plurality of bases are configured to be spliced together, and the plurality of bases are configured to be spliced together.

Each of the plurality of tapered springs is configured as the tapered spring with the changeable top size, and the plurality of tapered springs are independent and not connected to each other.

The present disclosure provides an elastic cushion, configured by splicing the spring modules, or comprising the tapered spring with the changeable top size.

Compared with the existing techniques, the technical solution has the following advantages.

1. By providing the tapered spring with the changeable top size, the structure of the tapered spring is utilized in conjunction with the adjustment member to enable a top size of the tapered spring to be adjustable. The adjustment member is positioned at the small end of the tapered spring. When the adjustment member is expanded to increase a top area of the tapered spring, the top size can approximate a size of the larger end of the tapered spring, ensuring that the spring maintains balance under compression.

2. By providing the tapered spring with the changeable top size, the top of the spring can be freely adjusted without compromising stability of the spring module, thereby preventing any imbalance in the performance or structural balance of the tapered spring.

3. By assembling the elastic cushion using the tapered spring with the changeable top sizes, the adjustment member can be rotated to be expanded to increase a contact area at the top of the spring, enhancing comfort.

### BRIEF DESCRIPTION OF THE DRAWINGS

FIG. 1 is a perspective view of a tapered spring in a preferred embodiment of the present disclosure.

FIG. 2 is an exploded view of the tapered spring in a preferred embodiment of the present disclosure.

FIG. 3 is a perspective view showing a top of the tapered spring in an expanded state in a preferred embodiment of the present disclosure.

FIG. 4 is a stacked view of the tapered springs in a preferred embodiment of the present disclosure.

FIG. 5 is a perspective view of the tapered springs assembled into a spring module in a preferred embodiment of the present disclosure.

FIG. 6 is a perspective view showing a top of the spring module in an expanded state in a preferred embodiment of the present disclosure.

FIG. 7 is a perspective view of the spring modules combined to form a spring network in a preferred embodiment of the present disclosure.

FIG. 8 is a perspective view showing a top of the spring network in an expanded state in a preferred embodiment of the present disclosure.

FIG. 9 is a perspective view showing a soft cushion layer laid on the spring network in a preferred embodiment of the present disclosure.

FIG. 10 is a perspective view showing the spring network and the soft cushion layer enclosed in a cloth cover in a preferred embodiment of the present disclosure.

FIG. 11 is a perspective view of an elastic cushion in a preferred embodiment of the present disclosure.

Explanation of the reference numerals: 1. tapered spring; 11. spring; 12. tapered fixed sleeve; 2. adjustment member; 21. expandable portion; 211. blade; 212. first sliding block; 213. second sliding block; 22. rotating portion; 221. base disc; 222. rotating disc; 223. sliding rail; 224. guiding rail; 3. base; 4. spring module; 5. elastic cushion; 6. cushion layer; 7. cloth cover.

### DETAILED DESCRIPTION OF THE EMBODIMENTS

The technical solutions in the embodiments of the present disclosure will be clearly and completely described below in conjunction with the drawings in the embodiments of the present disclosure. It is obvious that the described embodiments are only part of the embodiments of the present disclosure, rather than all the embodiments, and all other embodiments obtained by ordinary technicians in this field based on the embodiments of the present disclosure without making creative work are within the scope of protection of the present disclosure.

In the description of the present disclosure, it should be noted that the terms “upper”, “lower”, “inner”, “outer”, “top”, “bottom”, and the like indicate positions or positional relationships based on the positions or positional relationships shown in the drawings, and are only for the convenience of describing the present disclosure and simplifying the description, rather than indicating or implying that the device or element referred to must have a specific position, be constructed and operated in a specific position, and therefore should not be understood as limiting the present disclosure. In addition, the terms “first” and “second” are used for descriptive purposes only and should not be understood as indicating or implying relative importance.

In the description of the present disclosure, it should be noted that, unless otherwise clearly stipulated and limited, the terms “installed”, “provided with”, “mounted”, “connected”, etc. should be understood in a broad sense. For example, “connection” can be a wall-mounted connection, a detachable connection, or an integral connection. It can be a mechanical connection or an electrical connection. It can be a direct connection or an indirect connection through an intermediate medium. It can be the internal connection of two components. For ordinary technicians in this field, the specific meanings of the above terms in the present disclosure can be understood according to specific circumstances.

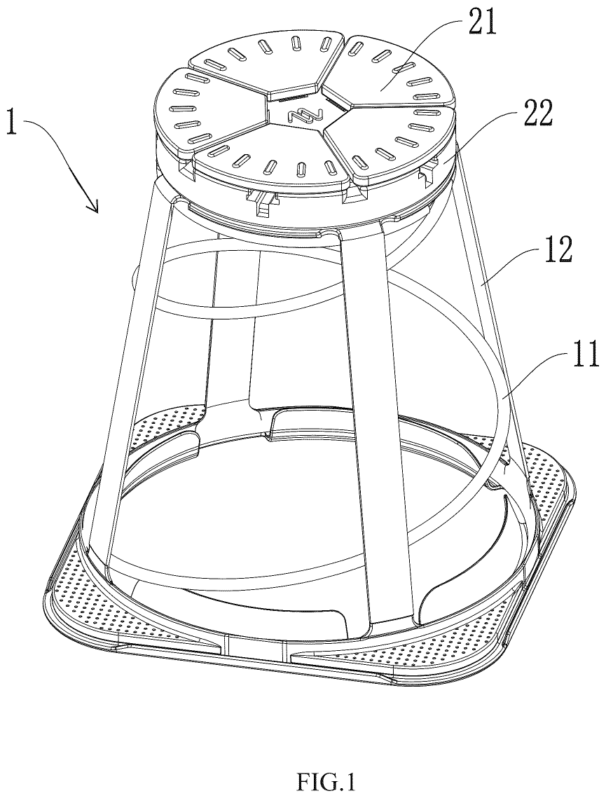

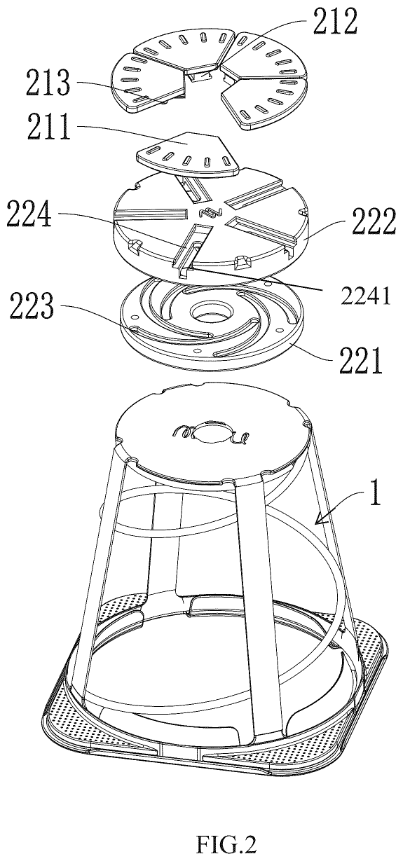

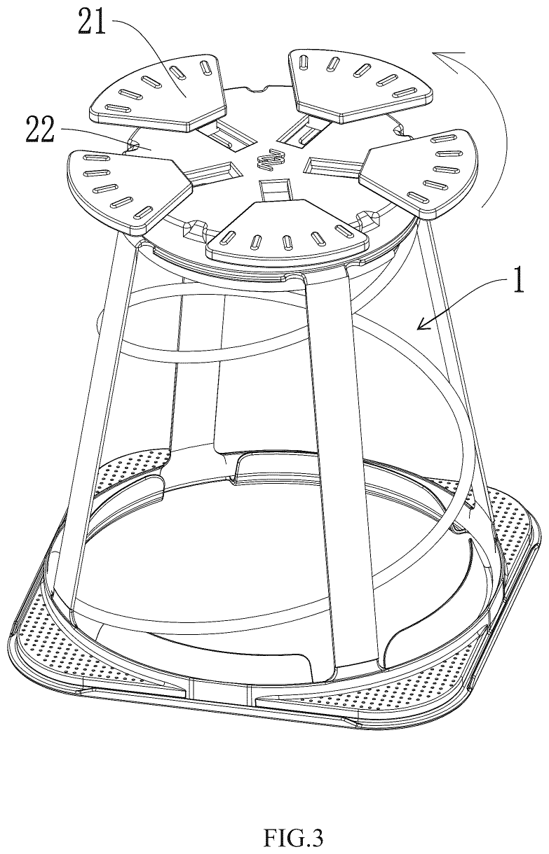

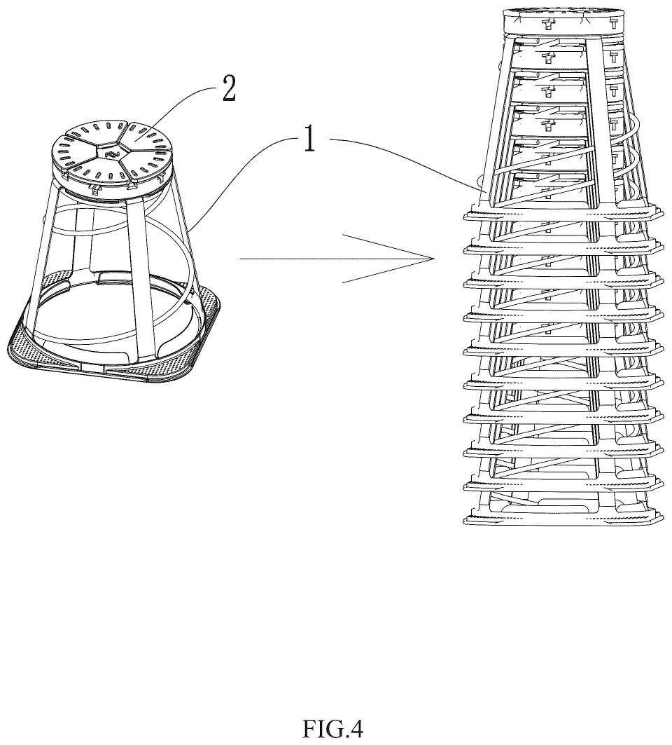

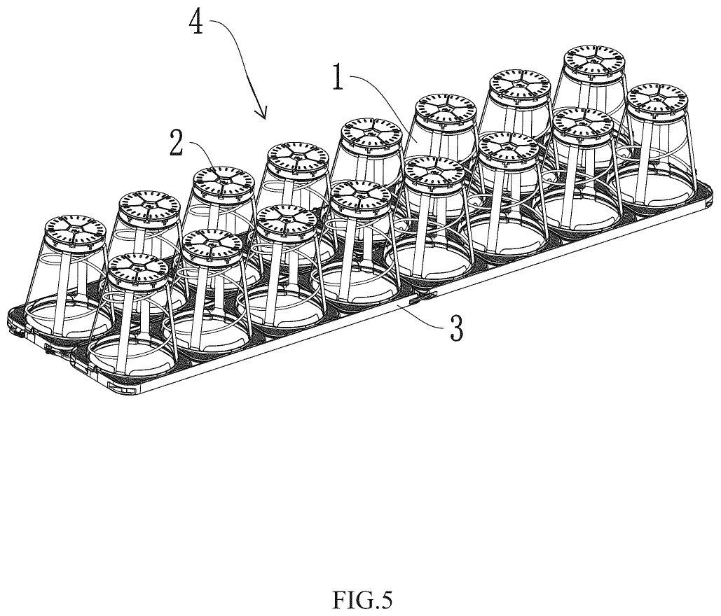

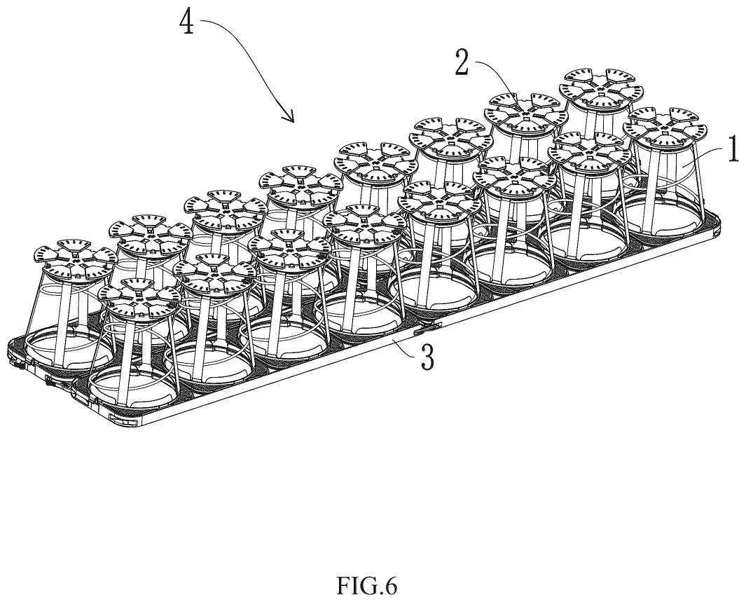

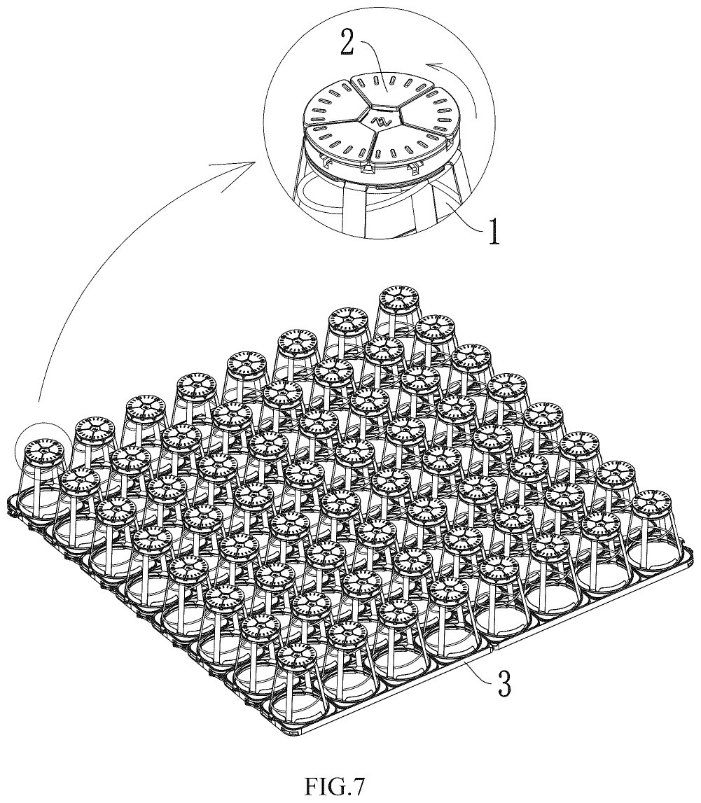

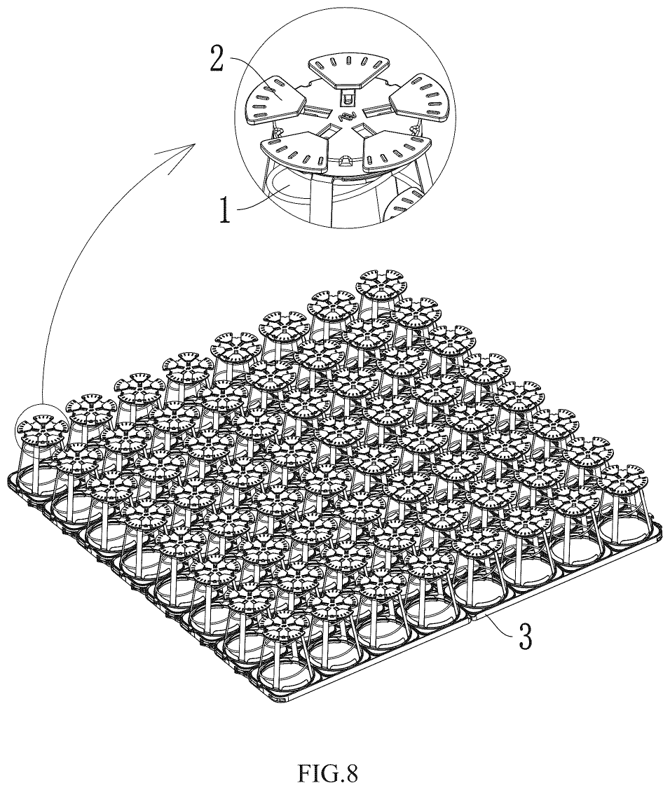

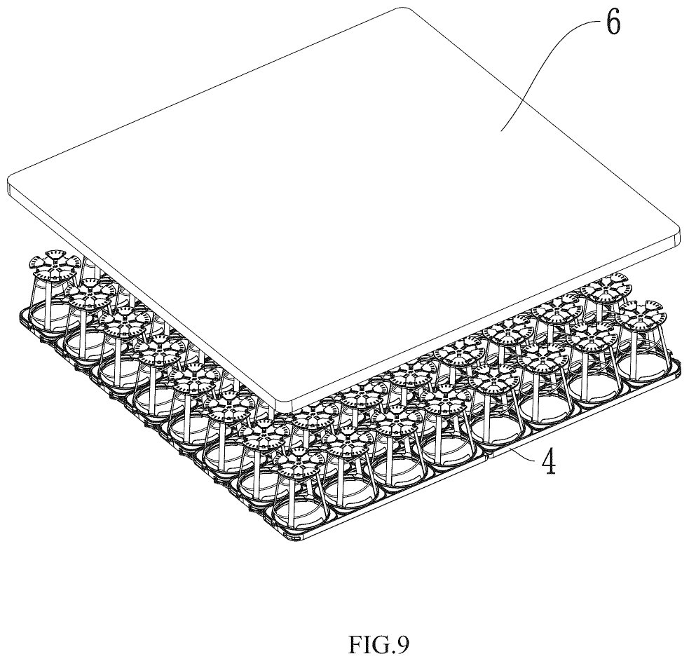

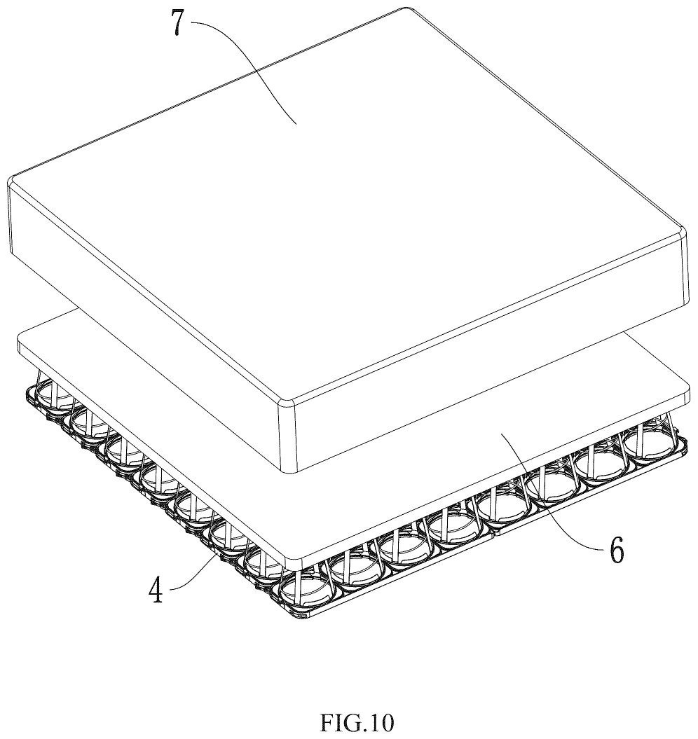

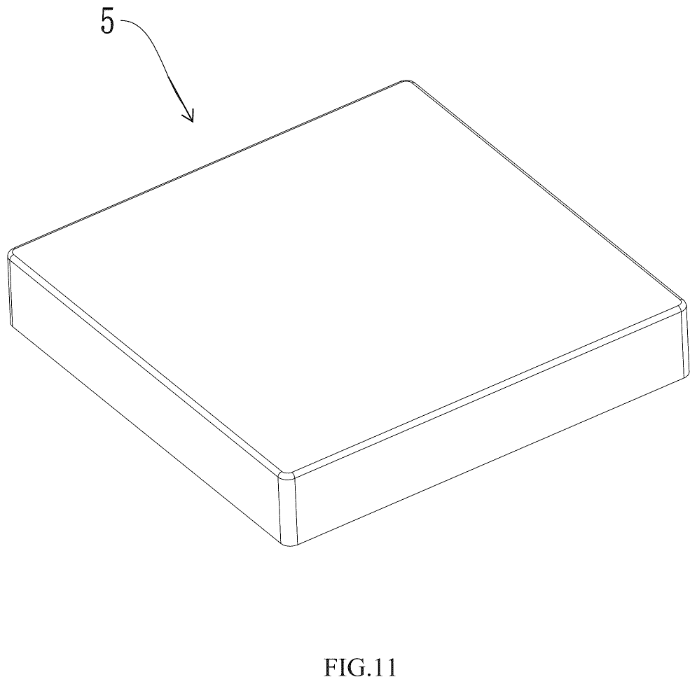

Referring to FIGS. 1-11, this embodiment provides a tapered spring 1 with a changeable top size. The tapered spring 1 comprises a spring 11 and a tapered fixed sleeve 12. The spring 11 is configured as a tapered structure, and the spring 11 is mounted in the tapered fixed sleeve 12.

An adjustment member 2 is disposed at a top of the tapered fixed sleeve 12 of the tapered spring 1, and the top of the tapered fixed sleeve 12 is a small end of the tapered fixed sleeve 12. The adjustment member 2 comprises an expandable portion 21, and the expandable portion 21 is configured to be expanded and contracted along a horizontal direction on a top end surface of the adjustment member 2. The expandable portion 21 can be expanded outward, and the expandable portion 21, which is expanded, forms an outward expansion surface on the top end surface of the adjustment member 2.

The expandable portion 21 can be expanded outward to change a size of the top of the tapered spring 1, which can increase a load-bearing area of the top of the tapered spring 1. The expandable portion 21 is disposed on the small end, and a large end of the tapered fixed sleeve 12 is not affected, so that stability of the spring 11 is not affected. Thus, a size of a top of the spring 11 can be adjusted at will without causing performance and structure of the spring 11 to be unbalanced.

After the expandable portion 21 is expanded, a projection of the expandable portion 21 in a vertical direction is less than or equal to a projection of a bottom of the tapered fixed sleeve 12, and the bottom of the tapered fixed sleeve 12 is the large end of the tapered fixed sleeve 12. After the expandable portion 21 is contracted, the projection of the expandable portion 21 in the vertical direction is less than or equal to the projection of the top of the tapered fixed sleeve 12. The tapered spring 1 is hollow, and when the expandable portion 21 is contracted, the tapered spring 1 can be stacked for storage. When the tapered spring 1 is assembled with other similarly configured tapered springs 1, the expandable portion 21 will not interfere with adjacent tapered springs 1 of when the expandable portion 21 is expanded.

A specific structure of the adjustment member 2 is that the adjustment member 2 comprises the expandable portion 21 and a rotating portion 22. The rotating portion 22 is rotatably connected to the top of the tapered fixed sleeve 12. The expandable portion 21 is operatively coupled to the rotating portion 22. Due to rotation driving of the rotating portion 22, the expandable portion 21 can be expanded outward or contracted inward.

The rotating portion 22 comprises a base disc 221 and a rotating disc 222. The base disc 221 is a fixed disc fixedly connected to the top of the tapered fixed sleeve 12, and the rotating disc 222 is rotatably mounted on the base disc 221. The expandable portion 21 comprises a plurality of blades 211. The plurality of blades 211 are movably mounted on the rotating disc 222 to be in a shape of a circle, and the plurality of blades 211 are petal-shaped movable sheets.

The base disc 221 comprises a plurality of sliding rails 223, and the rotating disc 222 comprises a plurality of guiding rails 224. A bottom of each of the plurality of blades 211 comprises a first sliding block 212 and a second sliding block 213. The first sliding block 212 is slidably connected in a corresponding one of the plurality of guiding rails 224, and the second sliding block 213 is slidably connected in a corresponding one of the plurality of sliding rails 223. Each of the plurality of blades 211 can be expanded and contracted horizontally due to cooperation between the first sliding block 212 and the corresponding one of the plurality of guiding rails 224 and due to cooperation between the second sliding block 213 and the corresponding one of the plurality of sliding rails 223.

Each of the plurality of blades 211 corresponds to a single one of the plurality of sliding rails 223 on the base disc 221 and a single one of the plurality of guiding rails 224 on the rotating disc 222. The plurality of sliding rails 223 are arc-shaped rails. The plurality of guiding rails 224 are linear guiding rails. A bottom of each of the plurality of guiding rails 224 comprises a channel 2241, and the second sliding block 213 passes through the channel 2241 and slides in a corresponding one of the plurality of sliding rails 223.

An expanded and contracted action of the expandable portion 21 is that when the rotating disc 222 is rotated, the rotating disc 222 rotates relative to the base disc 221, and the second sliding block 213 makes a curved motion along a corresponding one of the plurality of sliding rails 223. Due to movement of the second sliding block 213, the plurality of blades 211 start to move, and the first sliding block 212 makes a linear motion along a corresponding one of the plurality of guiding rails 224. At this time, the plurality of blades 211 start to expand outward or contract inward.

The present embodiment also provides a spring module 4, and the spring module 4 comprises the tapered springs 1 and a plurality of bases 3, which are configured to be spliced together. The plurality of bases 3 are configured to be spliced together, and the plurality of bases 3 and the tapered springs 1 are configured to be spliced together. The tapered springs 1 each have a changeable top size, and the tapered springs 1 are independent and not connected.

The spring modules 4 are configured to be spliced to form an elastic cushion 5. The elastic cushion 5 optionally comprises a cushion layer 6 on an upper layer of the spring module 4 and a cloth cover 7 covering the cushion layer 6 to be in a use state.

The above is only a preferred, specific implementation of the present disclosure, but the design concept of the present disclosure is not limited to this. Any technician familiar with the technical field who uses this concept to make non-substantial changes to the present disclosure within the technical scope disclosed by the present disclosure shall be deemed to infringe the protection scope of the present disclosure.

What is claimed is:

1. A tapered spring with a changeable top size, comprising:
a spring,
a tapered fixed sleeve, and
an adjustment member, wherein:
the spring is configured as a tapered structure,
the spring is mounted in the tapered fixed sleeve,
the adjustment member is disposed at a top of the tapered fixed sleeve,
the tapered fixed sleeve comprises a small end and a large end larger than the small end,
the top of the tapered fixed sleeve is the small end of the tapered fixed sleeve,
the adjustment member comprises an expandable portion,
the expandable portion is configured to be expanded and contracted along a horizontal direction on a top end surface of the adjustment member,
the expandable portion is configured to be expanded outward to form an outward expansion surface on the top end surface of the adjustment member, and
when the expandable portion is expanded:
a projection of the expandable portion in a vertical direction is less than or equal to a projection of a bottom of the tapered fixed sleeve, and
the bottom of the tapered fixed sleeve is the large end of the tapered fixed sleeve.

2. The tapered spring with the changeable top size according to claim 1, wherein:
the adjustment member comprises a rotating portion,
the rotating portion is rotatably connected to the top of the tapered fixed sleeve, and
the rotating portion is configured to be rotated to drive the expandable portion to be expanded outward or contracted inward along the horizontal direction.

3. The tapered spring with the changeable top size according to claim 2, wherein:
the expandable portion comprises a plurality of blades,
the plurality of blades are configured to be spliced in a shape of a circle, and
the plurality of blades are petal-shaped movable sheets.

4. The tapered spring with the changeable top size according to claim 3, wherein:
the rotating portion comprises a base disc and a rotating disc,
the base disc is a fixed disc fixedly connected to the top of the tapered fixed sleeve,
the rotating disc is rotatably mounted on the base disc, and
the plurality of blades are movably mounted on the rotating disc.

5. The tapered spring with the changeable top size according to claim 4, wherein:
the base disc comprises a plurality of sliding rails,
the rotating disc comprises a plurality of guiding rails,
a bottom of each of the plurality of blades comprises a first sliding block and a second sliding block,
the first sliding block is slidably connected in a corresponding one of the plurality of guiding rails,
the second sliding block is slidably connected in a corresponding one of the plurality of sliding rails, and
each of the plurality of blades is configured to be expanded and contracted horizontally due to cooperation between the first sliding block and the corresponding one of the plurality of guiding rails and cooperation between the second sliding block and the corresponding one of the plurality of sliding rails.

6. The tapered spring with the changeable top size according to claim 5, wherein:
each of the plurality of blades corresponds to a single one of the plurality of sliding rails on the base disc and a single one of the plurality of guiding rails on the rotating disc.

7. The tapered spring with the changeable top size according to claim 6, wherein:
the plurality of sliding rails are arc-shaped rails,
the plurality of guiding rails are linear guiding rails,
a bottom of each of the plurality of guiding rails comprises a channel, and
the second sliding block passes through the channel and slides in the corresponding one of the plurality of sliding rails.

8. The tapered spring with the changeable top size according to claim 1, wherein:
the tapered spring is hollow,
the tapered spring is configured to be stacked with other tapered springs, and
when the expandable portion is contracted, the projection of the expandable portion in the vertical direction is less than or equal to a projection of the top of the tapered fixed sleeve.

9. A spring module, comprising:
a plurality of tapered springs, and
a plurality of bases, wherein:
the plurality of tapered springs and the plurality of bases are configured to be spliced together,
the plurality of bases are configured to be spliced together,
each of the plurality of tapered springs is configured as the tapered spring with the changeable top size according to claim 1, and
the plurality of tapered springs are independent and not connected to each other.

10. An elastic cushion, configured by splicing the spring modules according to claim 9.

11. An elastic cushion, comprising the tapered spring with the changeable top size according to claim 1.
